(19) United States
(12) Patent Application Publication
(10) Pub. No.: US 2011/0219782 A1
(43) Pub. Date: Sep. 15, 2011

(54) AERODYNAMICALLY SHAPED SUPPORTING AND/OR FAIRING ELEMENT IN THE BYPASS DUCT OF A GAS-TURBINE ENGINE

(75) Inventor: Carsten CLEMEN, Mittenwalde (DE)

(73) Assignee: ROLLS-ROYCE DEUTSCHLAND LTD & CO KG, Blankenfelde-Mahlow (DE)

(21) Appl. No.: 13/039,861

(22) Filed: Mar. 3, 2011

(30) Foreign Application Priority Data
Mar. 10, 2010 (DE) 10 2010 002 719.7

(51) Int. Cl. F02C 7/20

(52) U.S. Cl. 60/796

(57) ABSTRACT

An aerodynamically shaped supporting and fairing element (2) is arranged in the bypass duct of a gas-turbine engine and includes a supporting structure (3, 4) of aerodynamically shaped leading-edge and trailing-edge parts (7 and 8) connected by a connecting web (9) to form a recess (10) which extends on both sides of and longitudinally to the supporting structure. A fairing inlay (11) having an aerodynamically shaped outer contour and flushly adjoining the leading-edge part and the trailing-edge part (7, 8) is detachably fitted, with the fairing inlay being made in the same material or in a lighter material having reduced sound reflection or even a sound-absorbing effect. The connecting web (9) can include cavities (14). Such a supporting and fairing element features reduced weight, generates less noise and can easily be maintained and repaired.

This application claims priority to German Patent Application DE102010002719.7 filed Mar. 10, 2010, the entirety of which is incorporated by reference herein.

This invention relates to an aerodynamically shaped supporting and/or fairing element which is arranged in the bypass duct of a gas-turbine engine and includes a supporting structure extending radially between an inner and an outer wall of the bypass duct.

On a turbofan engine the airflow produced by the fan is divided into a core airflow and a bypass airflow by way of a flow divider. The core air flows into a core-flow duct, which is surrounded by a bypass duct carrying the bypass airflow. The outer wall of the bypass duct formed by the engine fairing is supported at the wall of the core-flow duct by aerodynamically shaped supporting elements radially extending in the bypass duct. As the supporting elements are designed as hollow bodies, they may accommodate in their interior service lines radially extending in the bypass duct, drive shafts or supports for the attachment of the engine to the aircraft fuselage or the wings and thus simultaneously act as aerodynamic fairing elements for these aerodynamically unfavorably shaped installations. If the engine suspension fairing is provided in the bypass duct, the fairing and supporting element is connected to the pylon fairing and the support outside the bypass duct. Therefore, the fairing and supporting elements, on the one hand, have a mechanical function, on the other hand, they are intended to reduce pressure losses and vibrations due to their aerodynamic design as well as acoustical and mechanical disadvantages and negative effects on engine performance.

As is generally known, the fairing and supporting elements are made of two half shells, which support the outer and the inner wall of the bypass duct against each other, define the aerodynamic shape and are capable of accommodating in their interior the components to be faired. They are made of a metallic, a plastic or a composite material. Moreover one-part supporting and/or fairing elements are known.

The known supporting and/or fairing elements are disadvantageous in that they feature very high weight which incurs high fuel consumption. Moreover, the entire component or at least one half shell has to be replaced or repaired in case of damage. Furthermore the noise level generated by the supporting and fairing elements is still very high, despite the aerodynamic shaping of the elements.

A broad aspect of the present invention is to design the supporting and/or fairing elements provided in the bypass duct of a gas-turbine engine in such a way that their weight is reduced, their repair facilitated and the sound emission caused by the supporting and/or fairing elements is decreased.

The present invention, in its essence, provides that the supporting structure, which acts as supporting element and additionally also as fairing element, has aerodynamically shaped leading-edge and trailing-edge parts connected by a connecting web to form a recess which extends on both sides of and longitudinally to the supporting structure and in which a fairing inlay having an aerodynamically shaped outer contour and flushly adjoining the leading-edge part and the trailing-edge part is detachably fitted by a fastener. The connecting web, when simultaneously employed as a fairing element for aerodynamic fairing of installations extending radially in the bypass duct, is provided with cavities. Easy and cost-effective maintenance and repair are enabled by the multi-part configuration with separate fairing inlays with only the latter requiring repair or replacement.

The fairing inlays can be made in the same material as the supporting structure or, in accordance with a further advantageous feature of the present invention, in a material which is lighter than that of the supporting structure and has reduced sound reflection or even a sound-absorbing effect, thereby enabling the weight of the engine and the sound level produced by the engine to be decreased.

In accordance with a further feature of the present invention, the supporting structure is two-part or multi-part and includes threadedly interconnected individual parts. The cavities provided for fairing the installations arranged in the bypass duct are formed by recesses provided in adjacent areas of the individual parts. This enables a supporting element which simultaneously has a fairing function to be provided which can easily be manufactured, assembled or disassembled and repaired, as applicable.

In a further development of the present invention, the fairing elements are, for sound absorption, provided with an acoustic honeycomb structure which ensures high sound absorption and low noise generation.

In a further embodiment of the present invention, the trailing-edge part, or a pylon provided instead, is threadable to the front face of the connecting web.

In a useful embodiment of the present invention, the individual items of the supporting structure are attached to one another or to a pylon by threaded connections being flush with or recessed to the outer surface. As fasteners for fitting the fairing inlays, countersunk screws or recessed socket-head screws are provided. As fasteners for fitting the fairing inlays, a plug-type connection, including a plug-in receptacle and plug-in flap, can preferably be provided.

The fairing inlays can be single-part or also two-part or multi-part each.

The present invention is more fully described in light of the accompanying drawings showing preferred embodiments. In the drawings,

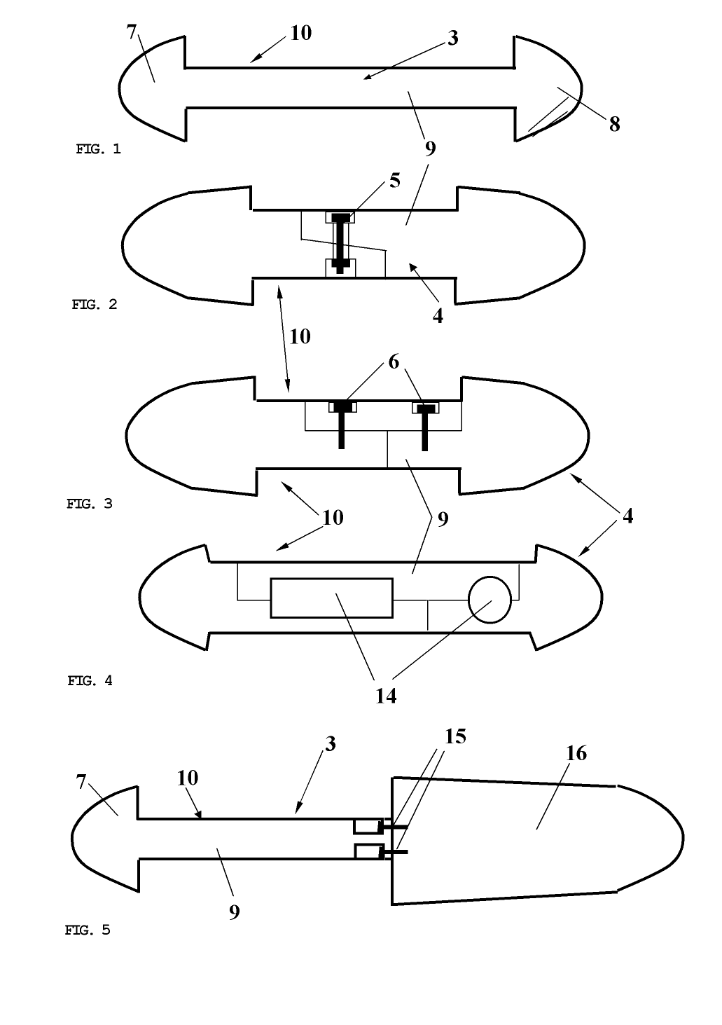

FIG. 1 is a sectional view of a one-part supporting structure for a supporting element arranged in the bypass duct, however without fairing inlays,

FIG. 2 is a sectional view of a two-part supporting structure for a supporting element, with the supporting structure being threadedly connected,

FIG. 3 is a sectional view of a three-part supporting structure for a supporting element,

FIG. 4 is a sectional view of a three-part supporting structure with cavities for accommodating and aerodynamically fairing the installations extending radially in the bypass duct,

FIG. 5 is a sectional view of a supporting structure with a pylon threaded to the trailing edge of the supporting structure,

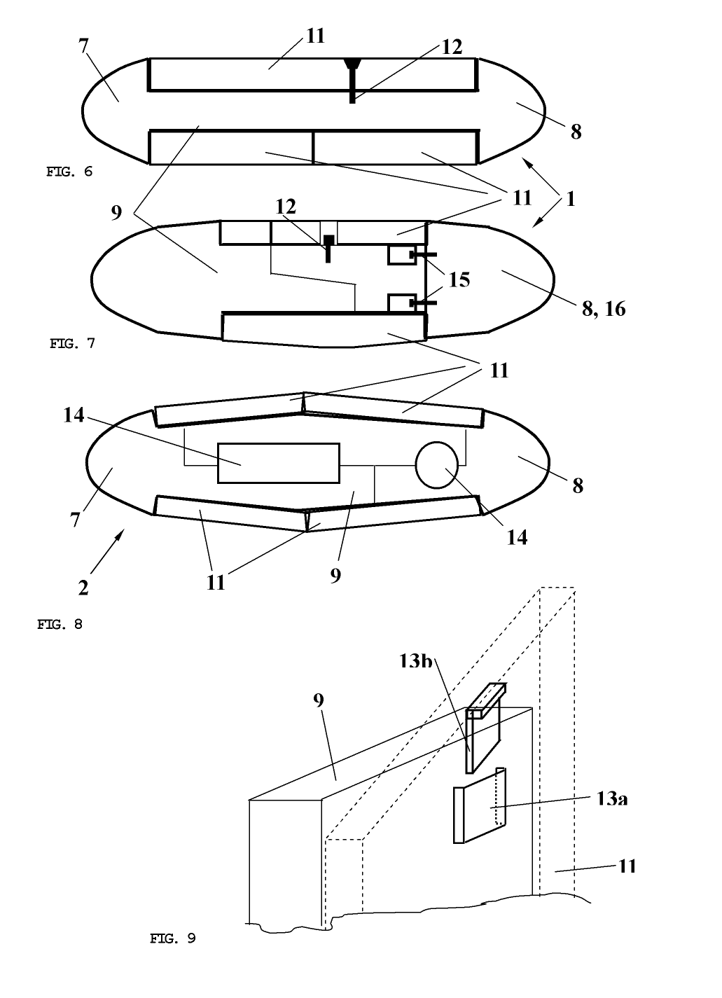

FIG. 6 shows a complete supporting element with fairing inlays provided in lateral recesses,

FIG. 7 shows a two-part supporting structure with a supporting element threaded to a pylon and including lateral fairing inlays,

FIG. 8 shows a supporting element with laterally arranged fairing inlays, with the supporting element simultaneously acting as fairing element for the installations provided in the bypass duct,

FIG. 9 is a schematic representation of a plug-type means of connection for fitting the fairing inlays to the supporting structure in an aerodynamically advantageous way.

FIGS. 6 to 8 show supporting elements 1 and supporting and fairing elements 2 arranged between the inner and the outer wall of the bypass duct of a gas-turbine engine (not shown) and having either only a supporting function (FIGS. 6 and 7) or additionally also a fairing function for installations, such as service lines or the like, extending radially in the bypass duct. The supporting elements 1, or the supporting and fairing elements 2, include a one-part supporting structure 3 (FIGS. 1 and 6) or a two-part or multi-part supporting structure 4 whose individual items 4a, 4b, 4c are joined by a threaded connection 5, 6 in such a manner that the screw heads and thread bolts thereof do not protrude beyond the outer surface of the supporting structure 4. The one-part supporting structure 3 and the at least two-part supporting structure 4 have an aerodynamically shaped leading-edge part 7 and an aerodynamically shaped trailing-edge part 8 between which a connecting web 9 is provided. The thickness of the connecting web 9 is less than the maximum width of the leading-edge part and the trailing-edge part 7, 8, so that an essentially rectangular recess 10 is formed at the side faces of the supporting structure 3, 4 extending in the longitudinal direction of the latter. Aerodynamically shaped fairing inlays 11 flushly adjoining the leading-edge part 7 and the trailing-edge part 8 (or a pylon 16) are fitted into said recesses 10 using a fastener 12 or 13. For fasteners 12, socket-head screws or countersunk screws 12 which do not protrude beyond the outer surface of the fairing inlays 11, or a plug-type connection 13 including a plug-in receptacle 13a and plug-in flap 13b are employed.

Adapted to the shape of the supporting element 1 or, respectively, the supporting and fairing element 2 and the respective flow conditions, the outer surface of the fairing inlay 11 is individually shaped for favorable flow conditions and minimum pressure losses and vibrations there.

The fairing inlays 11 can be made in the same material as the supporting structure 3 or 4. Already the multi-part configuration including the supporting structure 3, 4 and the fairing inlays 11 offers the advantage of easy repair and maintenance of the supporting elements 1 or, respectively, the supporting and fairing elements 2. Moreover, since a material different to that of the supporting structures 3, 4 may be employed for the fairing inlays 11, the latter are characterized, in particular, by low weight and properties by which sound waves are reflected to a lesser degree or even absorbed. Thus, the material used for the fairing inlays 11 can be lighter and less hard to reduce the overall weight and sound reflection at the outer surfaces, or the fairing inlays 11 can have a sound wave-absorbing acoustic honeycomb structure to further reduce the sound level generated in the bypass duct.

As shown in FIGS. 4 and 8, the supporting and fairing element 2 essentially differs from the mere supporting element 1 without fairing function in that recesses disposed opposite to one another are formed in the adjacent inner surfaces of the individual parts 4a, 4b, 4c of the supporting structure to provide cavities 14 for accommodating installations in the bypass duct which require aerodynamic fairing (for example service lines).

FIGS. 5 and 7 further illustrate that also a pylon 16 instead of the trailing-edge part 8 may be fitted to the connecting web 9 on a one-part or multi-part supporting structure 3 or 4, respectively, using a threaded connection 15.

### LIST OF REFERENCE NUMERALS

1 Supporting element
2 Supporting and fairing element
3 One-part supporting structure
4 Two-part or multi-part supporting structure
4a-4c Individual parts of 4
5 Threaded connection
6 Threaded connection
7 Leading-edge part
8 Trailing-edge part
9 Connecting web
10 Recess in 3, 4
11 Fairing inlay
12 Fastener for fairing inlay
13 Plug-type connection for fairing inlay
13a Plug-in receptacle
13b Plug-in flap
14 Cavity in 9
15 Threaded connection for 16
16 Pylon

What is claimed is:

1. An aerodynamically shaped element for at least one of supporting and fairing, and which is arranged in the bypass duct of a gas-turbine engine, comprising:
a supporting structure extending radially between an inner and an outer wall of the bypass duct, the supporting structure including:
aerodynamically shaped leading-edge and trailing-edge parts;
a connecting web connecting the leading-edge and trailing edge parts to form a recess which extends on both sides of and longitudinally to the supporting structure;
a fairing inlay having an aerodynamically shaped outer contour and flushly adjoining the leading-edge part and the trailing-edge part;
at least one fastener for detachably fitting the fairing inlay to the connecting web.

2. The aerodynamically shaped element of claim 1, wherein the supporting structure is of multi-part construction and includes threadedly interconnected individual parts.

3. The aerodynamically shaped element of claim 2, and further comprising at least one cavity in the connecting web when the aerodynamically shaped element is a fairing element and extends radially in the bypass duct.

4. The aerodynamically shaped element of claim 3, wherein the cavity is formed by at least one recess provided in adjacent areas of the individual parts.

5. The aerodynamically shaped element of claim 1, wherein the fairing inlay is constructed of a material which is lighter than that of the supporting structure and has at least one of a reduced sound reflection and a sound-absorbing effect.

6. The aerodynamically shaped element of claim 5, wherein the fairing inlay includes an acoustic honeycomb structure for sound absorption.

7. The aerodynamically shaped element of claim 1, wherein the trailing-edge part is connected to the connecting web with a threaded connection.

8. The aerodynamically shaped element of claim 2, wherein the individual parts are attached to one another by at least one threaded connection being at least one of flush with and recessed to the outer surface.

9. The aerodynamically shaped element of claim 1, and further comprising at least one of a countersunk screw and a recessed socket-head screw for fastening the fairing inlay to the connecting web.

10. The aerodynamically shaped element of claim 1, wherein the at least one fastener is a plug-type connection including a plug-in receptacle and plug-in flap.

11. The aerodynamically shaped element of claim 1, wherein the fairing inlay is of multi-part construction.

12. The aerodynamically shaped element of claim 1, wherein the trailing edge part is a pylon.
